(19) United States
(12) Patent Application Publication
(10) Pub. No.: US 2026/0212830 A1
(43) Pub. Date: Jul. 23, 2026

(54) Display control circuit and method of controlling display panel for improving dark band issue

(71) Applicant: NOVATEK Microelectronics Corp., Hsinchu (TW)

(72) Inventors: Hsueh-Chin Chung, Hsinchu County (TW); Chin-Hung Hsu, Taoyuan City (TW); Jian-Yu Pan, New Taipei City (TW); Huan-Teng Cheng, Hsinchu City (TW)

(73) Assignee: NOVATEK Microelectronics Corp., Hsinchu (TW)

(21) Appl. No.: 19/570,128

(22) Filed: Mar. 17, 2026

Related U.S. Application Data
(63) Continuation-in-part of application No. 18/767,955, filed on Jul. 9, 2024.
(60) Provisional application No. 63/536,487, filed on Sep. 4, 2023.

(51) Int. Cl. G09G 3/3266

(52) U.S. Cl. CPC G09G 3/3266; G09G 2300/043; G09G 2300/0819; G09G 2310/061; G09G 2310/08

(57) ABSTRACT

A display control circuit for controlling a display panel includes a timing generation circuit and a timing control circuit. The display panel is operating with a timing having a plurality of frame times, each of which having an active period and a blanking period. The timing generation circuit is configured to generate a reset control signal. The timing control circuit is configured to set a plurality of reset pulses having a reset cycle on the reset control signal in each of the frame times. The reset control signal is used for generating a plurality of reset signals to be output to the display panel. A total length of at least one of the plurality of frame times divided by the reset cycle is substantially equal to a first positive integer, and a length of the active period divided by the reset cycle is substantially equal to a second positive integer.

### CROSS REFERENCE TO RELATED APPLICATIONS

This application is a continuation-in-part of U.S. application Ser. No. 18/767,955, filed on Jul. 9, 2024, which claims the benefit of U.S. Provisional Application No. 63/536,487, filed on Sep. 4, 2023. The contents of these applications are incorporated herein by reference.

### BACKGROUND OF THE INVENTION

### 1. Field of the Invention

The present invention relates to a display control circuit for controlling a display panel and a related method, and more particularly, to a display control circuit for controlling an organic light emitting diode (OLED) panel and a related method.

### 2. Description of the Prior Art

In recent years, the dark band problem easily appears on a display panel under low luminance, especially on a low-temperature polycrystalline oxide (LTPO) organic light emitting diode (OLED) panel. At present, people in the industry mostly apply the Demura method to compensate for the brightness difference in the dark band. However, due to the insufficient compensation capabilities of Demura, the dark band problem cannot be completely solved. In addition, several product manufacturers apply an approach of dynamically adjusting the level of the initial voltage to solve the dark band problem, but this approach may affect other areas without dark bands. Further, if dynamic compensation is applied to adjust the initial voltage, it is not feasible to keep the voltage across the OLED constant, resulting in image sticking problems on the display panel. The long-term voltage offset at the OLED also causes different stresses in the pixel circuits within the dark band area, thereby reducing the reliability of the OLED panel.

### SUMMARY OF THE INVENTION

It is therefore an objective of the present invention to provide a novel display control circuit and a related method of controlling the display panel, to solve the abovementioned problems.

An embodiment of the present invention discloses a display

control circuit for controlling a display panel. The display panel operates with a timing having a plurality of frame times, each of which has an active period and a blanking period. The display control circuit comprises a timing generation circuit and a timing control circuit. The timing generation circuit is configured to generate a reset control signal. The timing control circuit, coupled to the timing generation circuit, is configured to set a plurality of reset pulses having a reset cycle on the reset control signal in each of the plurality of frame times. The reset control signal is used for generating a plurality of reset signals to be output to the display panel. A total length of at least one of the plurality of frame times divided by the reset cycle is substantially equal to a first positive integer, and a length of the active period divided by the reset cycle is substantially equal to a second positive integer.

Another embodiment of the present invention discloses a method of controlling a display panel. The display panel operates with a timing having a plurality of frame times, each of which has an active period and a blanking period. The method comprises steps of: generating a reset control signal; and setting a plurality of reset pulses having a reset cycle on the reset control signal in each of the plurality of frame times. The reset control signal is used for generating a plurality of reset signals to be output to the display panel. A total length of at least one of the plurality of frame times divided by the reset cycle is substantially equal to a first positive integer, and a length of the active period divided by the reset cycle is substantially equal to a second positive integer.

Another embodiment of the present invention discloses a display control circuit for controlling a display panel. The display panel operates with a timing having a plurality of frame times, each of which has an active period and a blanking period. The display control circuit comprises a timing generation circuit and a timing control circuit. The timing generation circuit is configured to generate a reset control signal. The timing control circuit, coupled to the timing generation circuit, is configured to set a plurality of reset pulses having a reset cycle on the reset control signal in each of the plurality of frame times. The reset control signal is used for generating a plurality of reset signals to be output to the display panel. A difference between N and a ratio of a total length of at least one of the plurality of frame times to the reset cycle is less than a first threshold, and a difference between M and a ratio of a length of the active period to the reset cycle is less than a second threshold, wherein M and N are positive integers.

Another embodiment of the present invention discloses a method of controlling a display panel. The display panel operates with a timing having a plurality of frame times, each of which has an active period and a blanking period. The method comprises steps of: generating a reset control signal; and setting a plurality of reset pulses having a reset cycle on the reset control signal in each of the plurality of frame times. The reset control signal is used for generating a plurality of reset signals to be output to the display panel. A difference between N and a ratio of a total length of at least one of the plurality of frame times to the reset cycle is less than a first threshold, and a difference between M and a ratio of a length of the active period to the reset cycle is less than a second threshold, wherein M and N are positive integers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a pixel circuit according to an embodiment of the present invention.

FIG. 2 is a timing diagram of control signals for driving a display panel.

FIGS. 3-5 illustrate an exemplary implementation of anode reset performed on a display panel.

FIG. 6 is a flowchart of a timing control process according to an embodiment of the present invention.

FIG. 7 is a timing diagram of the anode reset with an appropriate timing setting according to an embodiment of the present invention.

FIG. 8 is a timing diagram of the anode reset with another timing setting according to an embodiment of the present invention.

FIG. 9 is a timing diagram of the anode reset with a further timing setting according to an embodiment of the present invention.

FIG. 10 illustrates a consistent load achieved by setting the cycle of the reset pulses to meet the multiplicative relationship.

FIG. 11 is a timing diagram of the anode reset with a timing setting in multiple frame times according to an embodiment of the present invention.

FIG. 12 is a timing diagram of the anode reset with another timing setting in multiple frame times according to an embodiment of the present invention.

FIG. 13 is a flowchart of a timing control process according to an embodiment of the present invention.

FIG. 14 is a simplified schematic diagram of a display system according to an embodiment of the present invention.

### DETAILED DESCRIPTION

FIG. 1 is a schematic diagram of a pixel circuit 10 according to an embodiment of the present invention. The pixel circuit 10 includes transistors T1-T4, a storage capacitor CS and a light emitting device D1. The transistor T1 is a driving transistor, for generating a driving current to be provided for the light emitting device D1 according to a received display data VD, to control the light emitting device D1 to perform light emission. The transistor T2 is an input transistor, for forwarding the display data VD to the transistor T1 based on the control of a gate control signal GC. The transistor T3 is an emission control transistor, for enabling or disabling light emission of the pixel circuit 10 based on the control of an emission control signal EM. The transistor T4 is a reset transistor, which is controlled by a reset signal RST, to perform reset on the light emitting device D1. The storage capacitor CS is used for storing the display data VD, thereby keeping the desired brightness in a display period. The light emitting device D1, which may be an organic light emitting diode (OLED) or any other device capable of light emission, may emit light to generate a desired image according to the driving current received from the transistor T1. The pixel circuit 10 is operated by receiving power supply voltages ELVDD and ELVSS, where the power supply voltage ELVDD may be a positive voltage, and the power supply voltage ELVSS may be a negative voltage or ground voltage.

In general, the pixel circuit 10 may be a unit of a pixel array deployed on the active area of a display panel, where the pixel array is composed of multiple pixel circuits having a similar structure as shown in FIG. 1. The display panel may be controlled by a scan control circuit and a source driver circuit, where the scan control circuit provides the gate control signal GC, the emission control signal EM and the reset signal RST to the pixel array, and the source driver circuit provides the display data VD to the pixel array.

In one or some embodiments, the light emitting device D1 is an OLED. The cathode of the OLED is coupled to a terminal that supplies the power supply voltage ELVSS, and the anode of the OLED is coupled to the transistor T4. In the reset operations of the light emitting device D1, the transistor T4 may be turned on by the reset signal RST, to forward an initial voltage Vint to the anode of the OLED. This operation is referred to as “anode reset”. The anode reset may be performed periodically. For example, if an OLED panel supports an extremely low frame rate (e.g., 1 Hz), the anode reset may be performed multiple times within a frame time, to periodically reset the anode of the OLED to a specific voltage level. The anode reset operation can avoid unwanted light emission of the OLED in non-emissive periods. In addition, through the anode reset, all pixels on the display panel could be reset to the same level before the emission starts, allowing the storage capacitor CS to be charged or discharged from the same level, thereby keeping the displayed image consistent.

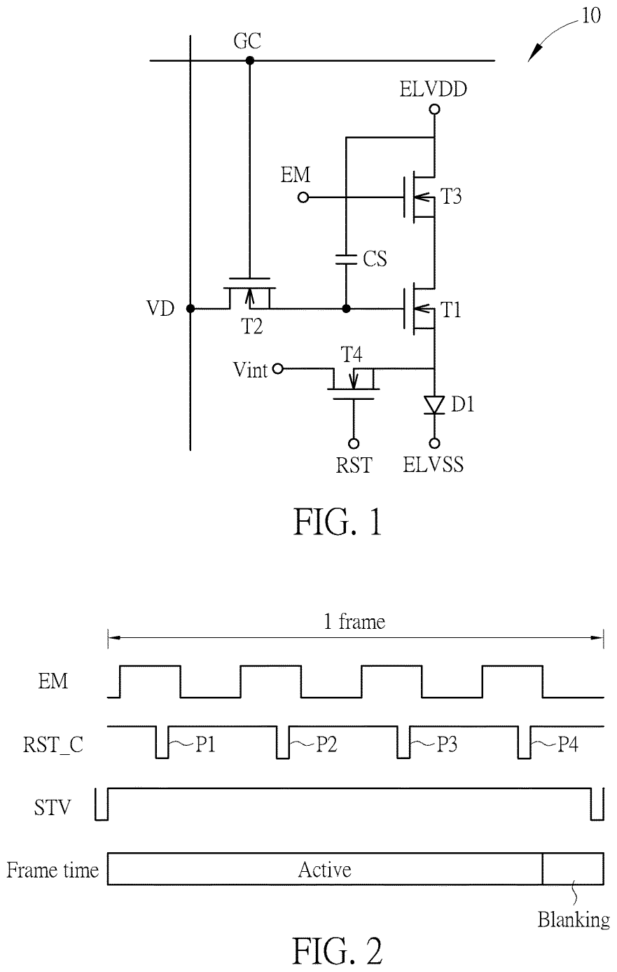

FIG. 2 is a timing diagram of control signals for driving a display panel. These control signals include an emission control signal EM, a reset control signal RST_C and a frame start pulse STV, where the arrangement of a frame time is also shown in FIG. 2 to facilitate the illustrations. As shown in FIG. 2, a frame time is defined by the frame start pulse STV, and includes an active period and a blanking period. The active period is a period of time in which the scan signal scans throughout the display panel and the display panel receives display data for displaying an image, and the blanking period is a period of time in which the display panel stops receiving display data.

The emission control signal EM may be provided to control the light emission of the pixel circuit 10. The reset control signal RST_C is used for generating multiple reset signals RST to be output to the display panel. As mentioned above, the reset signals RST may control the OLEDs in the corresponding pixel circuits to receive the initial voltage Vint for anode reset. More specifically, one of the reset signals RST is used to control a row of pixels, and the display panel may be scanned row by row to allow each reset signal RST to be received by the corresponding row of pixels. There may be one or more reset pulses on the reset signal RST, where the OLED in the pixels may receive the initial voltage Vint in the time period of the reset pulse(s). The reset control signal RST_C is used for generating the reset signals RST, and thus is configured with one or some reset pulses P1-P4, as shown in FIG. 2.

Through appropriate design of the reset control signal RST_C and the reset pulses P1-P4 thereon, the anode reset may be performed. In this embodiment, there are four reset pulses P1-P4 in one frame time, and thus the anode reset may be performed by four times in each frame time.

In one or some embodiments, the transistors of the pixel circuit are PMOS transistors (such as the transistors T1-T4 in the pixel circuit 10 shown in FIG. 1), and thus the reset signals RST are low-active signals. The reset control signal RST_C is used for generating the reset signals RST, and thus the reset pulses P1-P4 are low pulses that may turn on the corresponding transistors in “low” level.

Based on the scan timing of the display panel, the reset signals RST scan row by row from top to bottom. If there are four anode resets performed in one frame time, when the first reset pulse (e.g., P1) shifts to approximately ¼ of the position from top to bottom of the display panel, the second reset pulse (e.g., P2) starts to scan. When the first reset pulse (e.g., P1) shifts to approximately 2/4 of the position from top to bottom of the display panel, the second reset pulse (e.g., P2) shifts to approximately ¼ of the position, and the third reset pulse (e.g., P3) starts to scan at this moment. By the same token, the reset pulses P1-P4 may uniformly scan through the display panel in one frame time.

However, each frame time is composed of an active period and a blanking period. The reset pulses P1-P4 scan through the active area on the display panel in the active period, while scanning in a porch area in the blanking period. Note that each reset pulse P1-P4 controls the light emitting devices in a pixel row to receive the initial voltage Vint when the reset pulse scans in the active area of the display panel. However, when a reset pulse (e.g., any of P1-P4) scans to the porch area, it may not control any light emitting device to receive the initial voltage Vint at this time. This causes the load of the voltage source for anode reset to be reduced, resulting in an offset on the level of the initial voltage Vint.

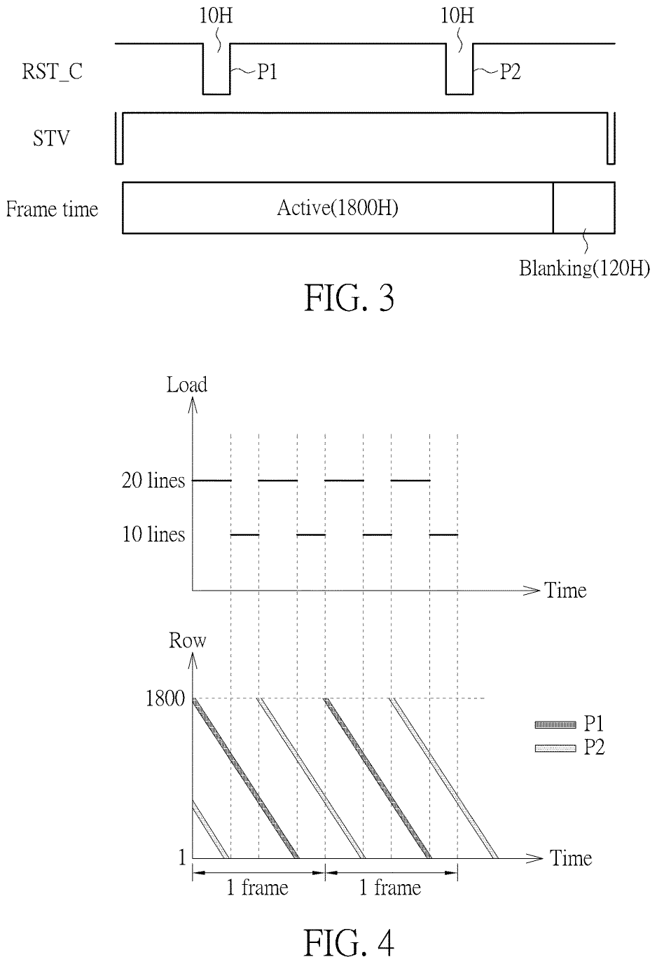

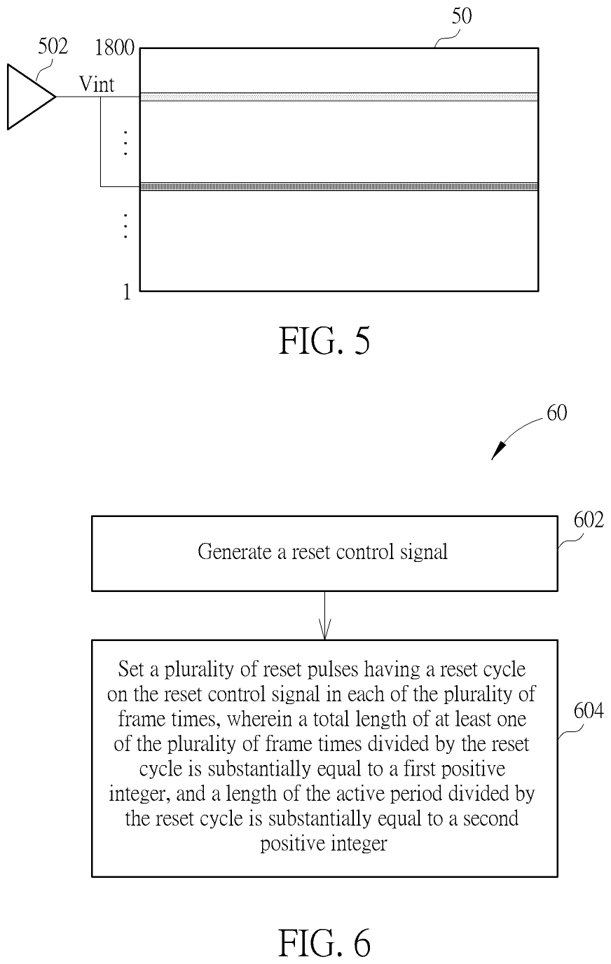

FIGS. 3-5 illustrate an exemplary implementation of anode reset performed on a display panel 50. In detail, FIG. 3 illustrates related waveforms of the reset control signal RST_C and the frame start pulse STV. FIG. 4 illustrates the scan of the reset signals RST to generate load variations. FIG. 5 illustrates the display panel 50 with a voltage source 502 that supplies the initial voltage Vint for anode reset.

In this embodiment, the vertical resolution of the display panel 50 is 1800; that is, there are 1800 horizontal lines of pixels on the display panel 50. In addition, the frame time equals 1920 line times. Therefore, the corresponding active period is 1800 line times (1800H), and the blanking period is 120 line times (120H), as shown in FIG. 3. On the reset control signal RST_C (and also the corresponding reset signals RST), there are two reset pulses P1 and P2 in the frame time, and the pulse width of each reset pulse P1 and P2 is 10 line times (10H).

As shown in FIG. 5, the voltage source 502 may supply the initial voltage Vint to all the pixels on the display panel 50. These pixels may receive the initial voltage Vint sequentially based on the scan operation of the reset signals RST. The voltage source 502 may be, for example, a voltage regulator implemented in the chip of the display control circuit, or in an independent power management integrated circuit (PMIC). The display control circuit (e.g., the timing controller) may control the reset signals RST to scan from top to bottom sequentially and repeatedly. Assuming that the bottommost row of pixels is numbered as row 1, and that the topmost row of pixels is numbered as row 1800, the reset pulses P1 and P2 sequentially scan from row 1800 toward row 1 and then enter the porch area. Since the pulse width is 10 line times, each reset pulse P1 and P2 may reset 10 lines of pixels when scanning to the active area, while resetting no pixels when scanning to the porch area. Therefore, when both reset pulses P1 and P2 scan to the active area, there are totally 20 lines of pixels performing anode reset, and thus the voltage source 502 has a load contributed from 20 lines of pixels. When one of the reset pulses P1 and P2 scans to the active area while the other one scans to the porch area, there are only 10 lines of pixels performing anode reset; hence, the load of the voltage source 502, which is contributed from 10 lines of pixels, is significantly reduced. The non-uniformity of the load will cause the initial voltage Vint received by the light emitting device to possess deviations, thus generating horizontal dark bands on the display panel 50.

U.S. application Ser. No. 18/767,955 has provided a method for handling the dark band issue, where an inter-frame dithering is introduced to dynamically change the output timing of the reset pulses. In such a situation, the time intervals between adjacent reset pulses may vary between different image frames, thereby dispersing the dark bands in different image frames, to mitigate the impact of the dark bands on visual effects.

The present invention provides another method for handling the dark band issue. In the present invention, the length of a frame time, the length of an active period, and the cycle of the reset pulses are controlled appropriately to achieve desired multiplicative relationship, thereby improving the dark band problem.

FIG. 6 is a flowchart of a timing control process 60 according to an embodiment of the present invention. The timing control process 60 may be implemented in a display control circuit, for controlling a display panel to avoid the dark band problem while performing anode reset. As shown in FIG. 6, the timing control process 60 includes the following steps:

Step 602: Generate a reset control signal.

Step 604: Set a plurality of reset pulses having a reset cycle on the reset control signal in each of the plurality of frame times, wherein a total length of at least one of the plurality of frame times divided by the reset cycle is substantially equal to a first positive integer, and a length of the active period divided by the reset cycle is substantially equal to a second positive integer.

According to the timing control process 60, the display control circuit may generate a reset control signal such as the reset control signal RST_C shown in FIG. 1. The display control circuit may also set multiple reset pulses on the reset control signal, where the reset pulses may control each pixel row on the display panel to perform anode reset at suitable time. The reset pulses may appear periodically and uniformly, thereby periodically performing the anode reset at suitable time. In some embodiments, the reset pulses have a fixed reset cycle throughout one or more frame times.

In one or some embodiments, the reset pulses may be set up to allow the reset cycle of the reset pulses along with the frame time and the active period and/or blanking period to meet specific criteria. For example, assuming that A represents the length of one frame time, and that B represents the reset cycle of the reset pulses, the timing should meet a criterion that A divided by B is substantially equal to a positive integer. Specifically, the value A, the length of one frame time, may refer to the overall time length or the total number of lines in the frame time. The value B, the reset cycle of the reset pulses, may refer to the interval between the start points (or end points) of every two adjacent reset pulses, including a pulse width plus a non-conductive period. The values A and B should meet a first criterion A/B=N, where N is a positive integer. This means that A is an integer multiple of B.

In addition, assuming that C represents the length of an active period, the timing should meet a criterion that C divided by B is substantially equal to a positive integer. Specifically, the value C, the length of an active period, may refer to the overall time length or the total line times in the active period. The values C and B should meet a second criterion C/B=M, where M is a positive integer. This means that C is an integer multiple of B.

Note that the length of the blanking period is equal to A minus C. Since A is an integer multiple of B and C is an integer multiple of B, it can be inferred that the length of the blanking period is also an integer multiple of B.

If both of the first criterion and the second criterion are met, the load experienced by the voltage source for anode reset will be consistent. This is because the number of pixels undergoing anode reset remains consistent during the scan operation of the reset pulses.

In the prior art, the frame time is usually designed to have an extremely short blanking period. For example, the blanking period may occupy less than one-tenth of the total frame time. In addition, the display panel may be designed to perform anode reset by 3 or 4 times, and thus there may be 3 or 4 reset pulses in each frame time, which means that the reset cycle is one-third or one-fourth of the total frame time. In such a situation, the reset cycle along with the lengths of the frame time and the active/blanking period could not easily meet the multiplicative relationship as described above.

According to the present invention, instead, the blanking period may be extended and/or the number of reset pulses may be increased (which means that the reset cycle is decreased), allowing the reset cycle along with the lengths of the frame time and the active/blanking period to simultaneously meet the desired multiplicative relationship.

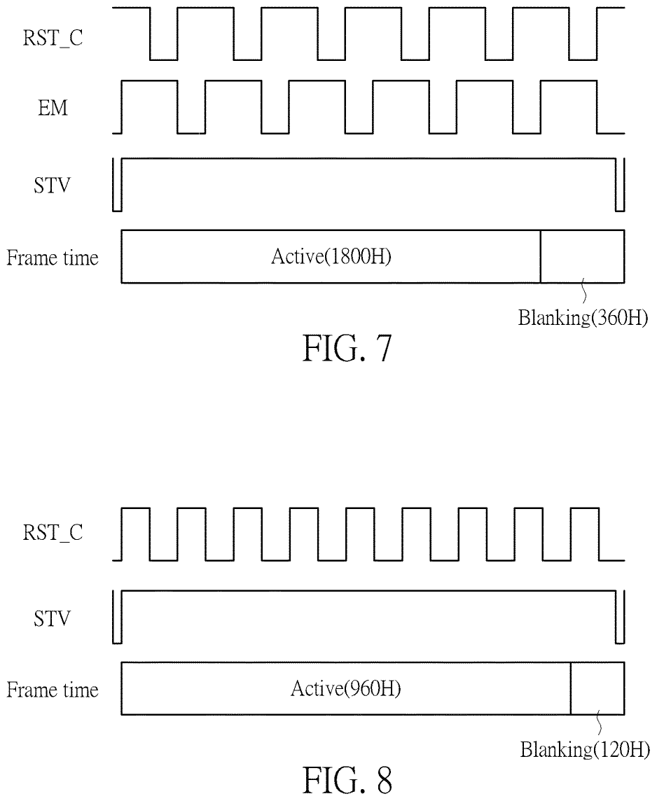

FIG. 7 is a timing diagram of the anode reset with an appropriate timing setting according to an embodiment of the present invention. In this embodiment, the frame time equals 2160 line times (2160H), which is composed of an active period equal to 1800 line times (1800H) and a blanking period equal to 360 line times (360H). The anode reset is performed 6 times in this frame, and thus the reset cycle equals 360 line times.

Considering the timing of the length of the frame time (A=2160H), the reset cycle (B=360H), and the length of the active period (C=1800H), these parameters meet the desired multiplicative relationship that A/B equals a positive integer and C/B equals a positive integer.

Specifically, A/B=6 and C/B=5, which means that there are 6 reset pulses scanning simultaneously, and at each moment, there are exactly 5 reset pulses scanning to the active area, while the other one reset pulse scanning to the porch area. In other words, when a reset pulse enters the porch area from the active area, there is always another reset pulse in the active area entering the porch area simultaneously. Therefore, in a series of frame times with the same timing setting as shown in FIG. 7, the voltage source for anode reset will always have a consistent load corresponding to 5 reset pulses, and thus the dark band issue can be improved.

FIG. 7 also illustrates the emission control signal EM, which is also a low-active signal that enables light emission of the corresponding pixels when the signal goes low. Note that during the anode reset operation, the initial voltage applied to the light emitting device may influence the current received by the light emitting device. Therefore, it is preferable to set the reset pulses in time periods where the light emission is disabled; that is, the reset pulses should be contained within the high pulse of the emission control signal EM. The duty cycle of the emission control signal EM may be determined according to the brightness requirement of the display panel, while the high pulse of the emission control signal EM is requested to be wide enough to contain the reset pulses.

FIG. 8 is a timing diagram of the anode reset with another timing setting according to an embodiment of the present invention. In this embodiment, the frame time equals 1080 line times (1080H), which is composed of an active period equal to 960 line times (960H) and a blanking period equal to 120 line times (120H). The anode reset is performed 9 times in this frame, and thus the reset cycle equals 120 line times.

Considering the timing of the length of the frame time (A=1080H), the reset cycle (B=120H), and the length of the active period (C=960H), these parameters meet the desired multiplicative relationship that A/B equals a positive integer and C/B equals a positive integer.

Specifically, A/B=9 and C/B=8, which means that there are 9 reset pulses scanning simultaneously, and at each moment, there are exactly 8 reset pulses scanning to the active area, while the other one reset pulse scanning to the porch area. In other words, when a reset pulse enters the porch area from the active area, there is always another reset pulse in the active area entering the porch area simultaneously. Therefore, in a series of frame times with the same timing setting as shown in FIG. 8, the voltage source for anode reset will always have a consistent load corresponding to 8 reset pulses, and thus the dark band issue can be improved.

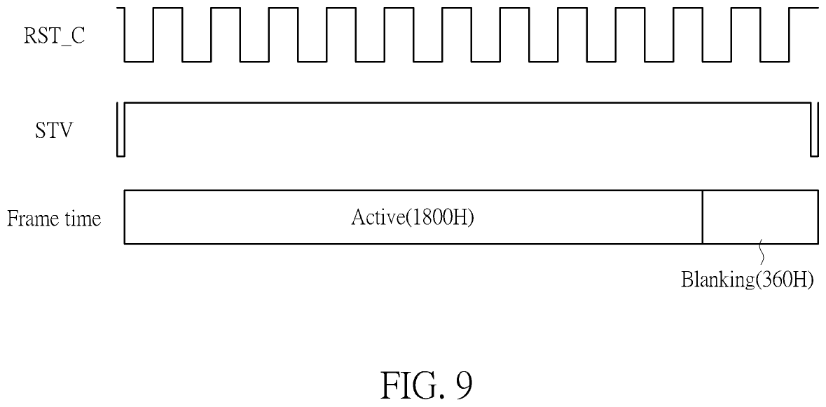

FIG. 9 is a timing diagram of the anode reset with a further timing setting according to an embodiment of the present invention. In this embodiment, the frame time equals 2160 line times (2160H), which is composed of an active period equal to 1800 line times (1800H) and a blanking period equal to 360 line times (360H). The anode reset is performed 12 times in this frame, and thus the reset cycle equals 180 line times.

Considering the timing of the length of the frame time (A=2160H), the reset cycle (B=180H), and the length of the active period (C=1800H), these parameters meet the desired multiplicative relationship that A/B equals a positive integer and C/B equals a positive integer.

Specifically, A/B=12 and C/B=10, which means that there are 12 reset pulses scanning simultaneously, and at each moment, there are exactly 10 reset pulses scanning to the active area, while the other two reset pulses scanning to the porch area. In other words, when a reset pulse enters the porch area from the active area, there is always another reset pulse in the active area entering the porch area simultaneously. Therefore, in a series of frame times with the same timing setting as shown in FIG. 9, the voltage source for anode reset will always have a consistent load corresponding to 10 reset pulses, and thus the dark band issue can be improved.

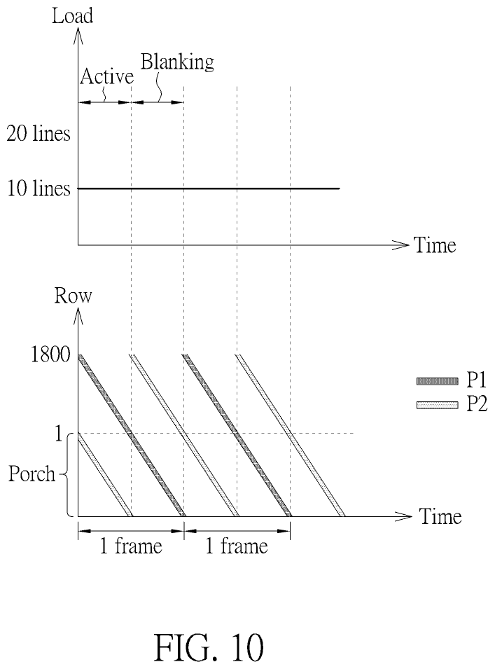

FIG. 10 illustrates a consistent load achieved by setting the reset cycle to meet the multiplicative relationship with the frame time and the active and blanking periods. In this embodiment, each frame time has two reset pulses P1 and P2, each having a pulse width equal to 10 line times (10H), as similar to the case shown in FIG. 4, while the length of the blanking period is equal to the length of the active period. This timing setting meets the multiplicative relationship as described above. As shown in FIG. 10, at the moment when one reset pulse enters the porch area from the active area, the other reset pulse enters the active area from the porch area. Therefore, at each moment, one of the reset pulses P1 and P2 is scanning in the porch area, while the other one is scanning in the active area, thereby keeping the load of the voltage source for anode reset consistent.

Referring back to FIG. 6, Step 602 specifies that the total length of at least one of the frame times divided by the reset cycle is substantially equal to a first positive integer. In the above embodiments as shown in FIGS. 7-9, the parameter A indicates the length of one frame time. In another embodiment, it is feasible to control the length of multiple frame times and the reset cycle to have a multiplicative relationship.

For example, assuming that A′ represents the length of multiple frame times, while B represents the reset cycle of the reset pulses and C represents the length of each active period, the timing should meet the criteria that A′ divided by B is substantially equal to a positive integer and C divided by B is substantially equal to a positive integer. In such a situation, A′ is an integer multiple of B and C is an integer multiple of B.

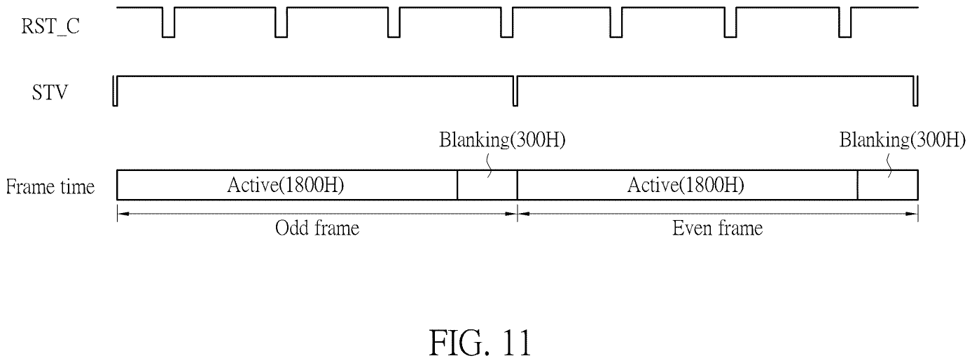

For example, FIG. 11 is a timing diagram of the anode reset with a timing setting in multiple frame times according to an embodiment of the present invention. In this embodiment, each frame time equals 2100 line times (2100H), which is composed of an active period equal to 1800 line times (1800H) and a blanking period equal to 300 line times (300H). The reset cycle equals 600 line times, and thus the anode reset is performed 7 times in every two frames.

Considering the timing of the total length of the two frame times (A′=2100H×2), the reset cycle (B=600H), and the length of the active period (C=1800H), these parameters meet the desired multiplicative relationship that A′/B equals a positive integer 7 and C/B equals a positive integer 3. Therefore, in a series of frame times where the odd frames and even frames are arranged to have the timing settings as shown in FIG. 11, the overall load of the voltage source for anode reset in every two frame times will be consistent, and thus the dark band issue can be improved.

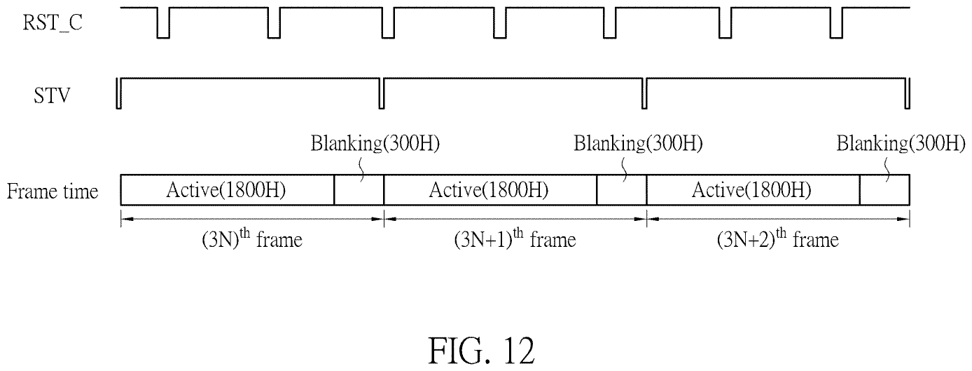

FIG. 12 is a timing diagram of the anode reset with another timing setting in multiple frame times according to an embodiment of the present invention. In this embodiment, each frame time equals 2100 line times (2100H), which is composed of an active period equal to 1800 line times (1800H) and a blanking period equal to 300 line times (300H). The reset cycle equals 900 line times, and thus the anode reset is performed 7 times in every three frames.

Considering the timing of the total length of the three frame times (A′=2100H×3), the reset cycle (B=900H), and the length of the active period (C=1800H), these parameters meet the desired multiplicative relationship that A′/B equals a positive integer 7 and C/B equals a positive integer 2. Therefore, in a series of frame times where every (3N)^{th} frame, (3N+1)^{th} frame and (3N+2)^{th} frame (where N may be any integer) are arranged to have the timing settings as shown in FIG. 12, the overall load of the voltage source for anode reset in every three frame times will be consistent, and thus the dark band issue can be improved.

Note that the present invention aims at providing a method of controlling the timing settings of the reset control signal and a related display control circuit. Those skilled in the art may make modifications and alterations accordingly. For example, the timing setting methods of the present invention are applicable to any pixel structure having a light emitting device, where the pixel circuit 10 shown in FIG. 1 is merely an example. In addition, the timing settings may be implemented in any manner. In one or some embodiments, given predetermined lengths of the frame time and the active period, the reset pulses may be set and controlled to meet the desired multiplicative relationship. In another embodiment, given a predetermined reset cycle, the active period and/or the frame time may be designed to meet the desired multiplicative relationship.

In the above embodiments, the multiplicative relationship specifies that A/B (or A′/B) substantially equals a positive integer and C/B substantially equals a positive integer. However, in some embodiments, the perfect multiplicative relationship in the timing design may not be easily achieved. In such a situation, A/B (or A′/B) may not need to be exactly equal to a positive integer, but approximate a positive integer instead; and C/B may not need to be exactly equal to a positive integer, but approximate a positive integer instead. The approximation may also achieve an improvement on the dark band problem.

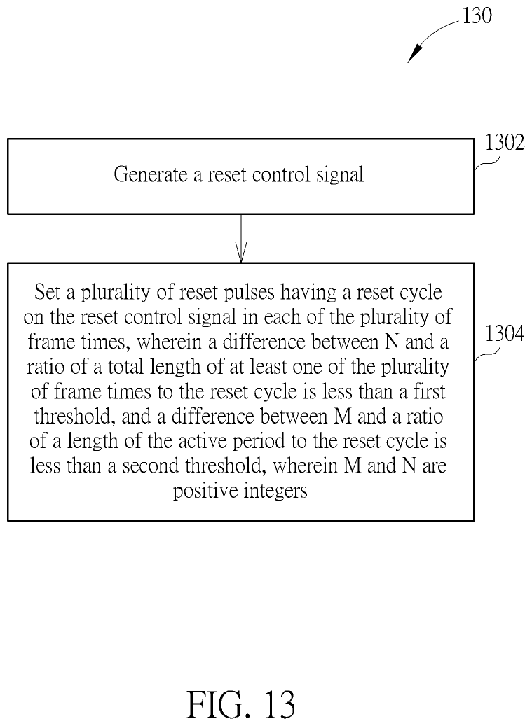

FIG. 13 is a flowchart of a timing control process 130 according to an embodiment of the present invention. The timing control process 130 may be implemented in a display control circuit, for controlling a display panel to mitigate the dark band problem while performing anode reset. As shown in FIG. 13, the timing control process 130 includes the following steps:

Step 1302: Generate a reset control signal.

Step 1304: Set a plurality of reset pulses having a reset cycle on the reset control signal in each of the plurality of frame times, wherein a difference between N and a ratio of a total length of at least one of the plurality of frame times to the reset cycle is less than a first threshold, and a difference between M and a ratio of a length of the active period to the reset cycle is less than a second threshold, wherein M and N are positive integers.

According to the timing control process 130, the display control circuit may generate a reset control signal such as the reset control signal RST_C shown in FIG. 1. The display control circuit may also set multiple reset pulses on the reset control signal, and the timing of the reset pulses meets the criteria as described below.

Similarly, assuming that A represents the length of one frame time, and that B represents the reset cycle of the reset pulses, the timing should meet a criterion that the difference between N and the ratio of A to B is less than a first threshold, where N is a positive integer, and the first threshold may be any appropriate value (e.g., 0.2). Mathematically, it can be represented as the absolute value of (A/B)−N is less than a first threshold, where N may be explicitly defined as the integer closest to A divided by B. In detail, the multiplicative relationship of A and B means that the remainder of A divided by B is 0, where the dark bands could be completely eliminated. In this embodiment, the difference between N and the ratio of A to B is less than a first threshold, and this means that the remainder of A divided by B is less than the first threshold to be close to 0 (or greater than another threshold to be close to 1). If the remainder is close to 0 or 1, the dark band issue may still be improved.

In addition, assuming that C represents the length of an active period, the timing should meet a criterion that the difference between M and the ratio of C to B is less than a second threshold, where M is a positive integer, and the second threshold may be any appropriate value (e.g., 0.2), and the second threshold may be or may not be equal to the first threshold. Mathematically, it can be represented as the absolute value of (C/B)−M is less than a second threshold, where M may be explicitly defined as the integer closest to C divided by B. In detail, the multiplicative relationship of C and B means that the remainder of C divided by B is 0, where the dark bands could be completely eliminated. In this embodiment, the difference between M and the ratio of C to B is less than a second threshold, and this means that the remainder of C divided by B is less than the second threshold to be close to 0 (or greater than another threshold to be close to 1). If the remainder is close to 0 or 1, the dark band issue may still be improved.

In another embodiment, assuming that A′ represents the length of multiple frame times, while B represents the reset cycle of the reset pulses and C represents the length of each active period, the timing should meet the criteria that the difference between N and the ratio of A′ to B is less than a first threshold and the difference between M and the ratio of C to B is less than a second threshold, where M and N are positive integers. This timing setting may also improve the dark band issue.

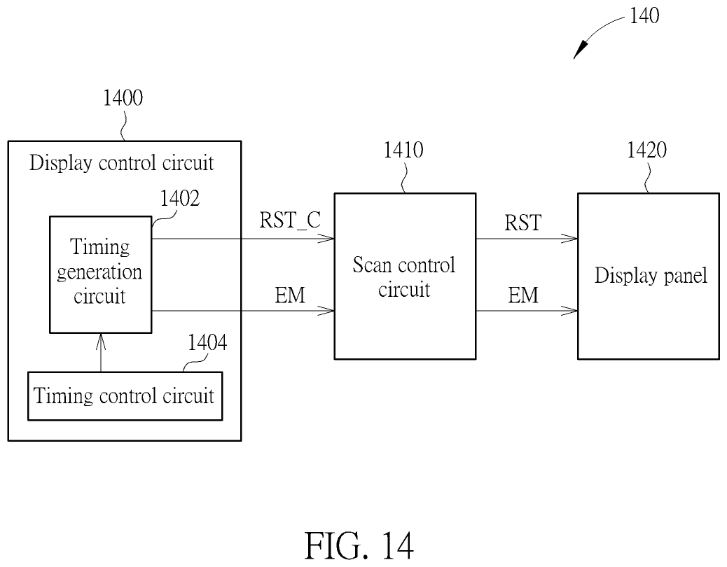

FIG. 14 is a simplified schematic diagram of a display system 140 according to an embodiment of the present invention. The display system 140 includes a display control circuit 1400, a scan control circuit 1410 and a display panel 1420. The display control circuit 1400 may be or include a timing controller, which may control and adjust the timing of the control signals for controlling the display panel 1420, and these control signals include, but not limited to, the reset control signal RST_C and the emission control signal EM.

In this embodiment, the display control circuit 1400 includes a timing generation circuit 1402 and a timing control circuit 1404. The timing generation circuit 1402 is configured to generate the reset control signal RST_C, which is output to the scan control circuit 1410. The scan control circuit 1410 then shifts the reset control signal RST_C to generate multiple reset signals RST. Subsequently, the scan control circuit 1410 outputs the reset signals RST to scan the pixel array line by line to perform anode reset. In one or some embodiments, the scan control circuit 1410 may be a gate-on-array (GOA) circuit, which is implemented with one or more level shifters for shifting the reset control signal RST_C, but not limited thereto.

The timing control circuit 1404 is configured to set multiple reset pulses on the reset control signal RST_C. Since the reset signals RST are generated by shifting the reset control signal RST_C, the reset pulses may also be shifted to be included in the reset signals RST. The timing control circuit 1404 may determine the reset cycle of the reset pulses to meet the above criteria for eliminating or improving the dark band problem accompanied by the anode reset. The detailed implementations of the reset pulses are described in the above paragraphs, and will not be narrated herein.

In addition, the timing generation circuit 1402 may also generate and output the emission control signal EM, and the scan control circuit 1410 may forward the emission control signal EM to the pixel array line by line. The emission control signal EM may be controlled appropriately to let the reset pulses to be contained within the high pulse of the emission control signal EM, thereby avoiding unwanted light emissions.

To sum up, the present invention provides a method of controlling the timing settings of the reset control signal to solve the dark band problem accompanied by the anode reset. The timing of the reset pulses on the reset control signal is set appropriately to eliminate or reduce load variations of the voltage source for anode reset. In one or some embodiments, the timing of the reset pulses may be set to meet specific criteria, allowing the load of the voltage source to be consistent. By eliminating or reducing the load variations, the level of the initial voltage received by the pixels may be consistent, thereby improving the dark band problem appearing on the display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display control circuit for controlling a display panel, the display panel operating with a timing having a plurality of frame times, each of which having an active period and a blanking period, the display control circuit comprising:
a timing generation circuit, configured to generate a reset control signal; and
a timing control circuit, coupled to the timing generation circuit, configured to set a plurality of reset pulses having a reset cycle on the reset control signal in each of the plurality of frame times,
wherein the reset control signal is used for generating a plurality of reset signals to be output to the display panel, and
wherein a total length of at least one of the plurality of frame times divided by the reset cycle is substantially equal to a first positive integer, and a length of the active period divided by the reset cycle is substantially equal to a second positive integer.

2. The display control circuit of claim 1, wherein the timing generation circuit is further configured to output the reset control signal to a scan control circuit, which generates the plurality of reset signals by shifting the reset control signal.

3. The display control circuit of claim 1, wherein each of the plurality of reset signals controls a plurality of pixels on the display panel to receive an initial voltage.

4. The display control circuit of claim 3, wherein the initial voltage is forwarded to an anode of a light emitting device of each of the plurality of pixels according to a corresponding reset signal among the plurality of reset signals.

5. The display control circuit of claim 3, wherein the plurality of pixels receive the initial voltage in a time period of the plurality of reset pulses.

6. A method of controlling a display panel, the display panel operating with a timing having a plurality of frame times, each of which having an active period and a blanking period, the method comprising:
generating a reset control signal; and
setting a plurality of reset pulses having a reset cycle on the reset control signal in each of the plurality of frame times,
wherein the reset control signal is used for generating a plurality of reset signals to be output to the display panel, and
wherein a total length of at least one of the plurality of frame times divided by the reset cycle is substantially equal to a first positive integer, and a length of the active period divided by the reset cycle is substantially equal to a second positive integer.

7. The method of claim 6, further comprising:
outputting the reset control signal to a scan control circuit, which generates the plurality of reset signals by shifting the reset control signal.

8. The method of claim 6, wherein each of the plurality of reset signals controls a plurality of pixels on the display panel to receive an initial voltage.

9. The method of claim 8, wherein the initial voltage is forwarded to an anode of a light emitting device of each of the plurality of pixels according to a corresponding reset signal among the plurality of reset signals.

10. The method of claim 8, wherein the plurality of pixels receive the initial voltage in a time period of the plurality of reset pulses.

11. A display control circuit for controlling a display panel, the display panel operating with a timing having a plurality of frame times, each of which having an active period and a blanking period, the display control circuit comprising:
a timing generation circuit, configured to generate a reset control signal; and
a timing control circuit, coupled to the timing generation circuit, configured to set a plurality of reset pulses having a reset cycle on the reset control signal in each of the plurality of frame times,
wherein the reset control signal is used for generating a plurality of reset signals to be output to the display panel,
wherein a difference between N and a ratio of a total length of at least one of the plurality of frame times to the reset cycle is less than a first threshold, and a difference between M and a ratio of a length of the active period to the reset cycle is less than a second threshold, and
wherein M and N are positive integers.

12. The display control circuit of claim 11, wherein the timing generation circuit is further configured to output the reset control signal to a scan control circuit, which generates the plurality of reset signals by shifting the reset control signal.

13. The display control circuit of claim 11, wherein each of the plurality of reset signals controls a plurality of pixels on the display panel to receive an initial voltage.

14. The display control circuit of claim 13, wherein the initial voltage is forwarded to an anode of a light emitting device of each of the plurality of pixels according to a corresponding reset signal among the plurality of reset signals.

15. The display control circuit of claim 13, wherein the plurality of pixels receive the initial voltage in a time period of the plurality of reset pulses.

16. A method of controlling a display panel, the display panel operating with a timing having a plurality of frame times, each of which having an active period and a blanking period, the method comprising:
generating a reset control signal; and
setting a plurality of reset pulses having a reset cycle on the reset control signal in each of the plurality of frame times,
wherein the reset control signal is used for generating a plurality of reset signals to be output to the display panel,
wherein a difference between N and a ratio of a total length of at least one of the plurality of frame times to the reset cycle is less than a first threshold, and a difference between M and a ratio of a length of the active period to the reset cycle is less than a second threshold, and
wherein M and N are positive integers.

17. The method of claim 16, further comprising:
outputting the reset control signal to a scan control circuit, which generates the plurality of reset signals by shifting the reset control signal.

18. The method of claim 16, wherein each of the plurality of reset signals controls a plurality of pixels on the display panel to receive an initial voltage.

19. The method of claim 18, wherein the initial voltage is forwarded to an anode of a light emitting device of each of the plurality of pixels according to a corresponding reset signal among the plurality of reset signals.

20. The method of claim 18, wherein the plurality of pixels receive the initial voltage in a time period of the plurality of reset pulses.
